(19) United States
(12) Patent Application Publication
(10) Pub. No.: US 2026/0095823 A1
(43) Pub. Date: Apr. 2, 2026

(54) Enhanced Cell Selection Logic During Mobility Operations

(71) Applicant: Apple Inc., Cupertino, CA (US)

(72) Inventors: Shadi ISKANDER, Ergolding (DE); Yuanye WANG, San Jose, CA (US); Tamer Adel Darweesh Hassan DARWEESH, Munich (DE)

(21) Appl. No.: 19/113,643

(22) PCT Filed: Sep. 19, 2023
(86) PCT No.: PCT/US2023/033118

§ 371 Date: Mar. 20, 2025

Related U.S. Application Data
(60) Provisional application No. 63/376,812, filed on Sep. 23, 2022.

(51) Int. Cl. H04W 36/00

(52) U.S. Cl. CPC H04W 36/0058; H04W 36/008357; H04W 36/0094

(57) ABSTRACT

A user equipment (UE) configured to decode, based on signals received from a network, one or more configured measurement objects (MOS), wherein a value of each MO corresponds to a mobility trigger, measure a first frequency range and a second frequency range of the network based on the MOs, detect a first cell in the first frequency range and a second cell in the second frequency range that satisfy the mobility trigger, determine a number of synchronization signal blocks (SSBs) to be transmitted by the first cell and the second cell and determine a periodicity of the SSBs for the first cell and the second cell.

### PRIORITY/INCORPORATION BY REFERENCE

This application claims priority to U.S. Provisional Application Ser. No. 63/376,812 filed on Sep. 23, 2022 and entitled “Enhanced Cell Selection Logic during Mobility Operations,” the entirety of which is incorporated herein by reference.

### BACKGROUND

Performing handover operations (i.e., mobility) to a cell that cannot support the same throughput as a current serving cell may cause significant user experience degradation during high throughput use cases.

Existing implementations of cellular networks require scheduling restrictions around Synchronization Signal Blocks (SSBs), SSB bursts, and measurement symbols. These restrictions may affect data throughput when SSBs and measurements are configured with a high frequency. These restrictions change according to the network configuration. One example of this behavior is that uplink (UL) and downlink (DL) data transmissions cannot be resumed while SSB measurements are ongoing, or while being configured by the network. This restriction is extended to several data symbols before and after the SSB measurement as well.

Typical network deployments configure multiple cells and frequencies to be measured by a user equipment (UE). Due to the dense deployment of New Radio (NR), there is a high likelihood that more than one cell satisfies the mobility criteria for the cellular device to trigger a handover operation. When this happens, the UE should prefer the cell on which network restrictions will not downgrade the performance.

### SUMMARY

Some exemplary embodiments are related to an apparatus of a user equipment (UE), the apparatus having processing circuitry configured to decode, based on signals received from a network, one or more configured measurement objects (MOS), wherein a value of each MO corresponds to a mobility trigger, measure a first frequency range and a second frequency range of the network based on the MOs, detect a first cell in the first frequency range and a second cell in the second frequency range that satisfy the mobility trigger, determine a number of synchronization signal blocks (SSBs) to be transmitted by the first cell and the second cell and determine a periodicity of the SSBs for the first cell and the second cell.

Other exemplary embodiments are related to a method for receiving, from a network, one or more configured measurement objects (MOS), wherein a value of each MO corresponds to a mobility trigger, measuring a first frequency range and a second frequency range of the network based on the MOs, detecting a first cell in the first frequency range and a second cell in the second frequency range that satisfy the mobility trigger, determining a number of synchronization signal blocks (SSBs) to be transmitted by the first cell and the second cell and determining a periodicity of the SSBs for the first cell and the second cell.

Still further exemplary embodiments are related to a user equipment (UE) having a transceiver configured to communicate with a network and a processor communicatively coupled to the transceiver and configured to decode, based on signals received from a network, one or more configured measurement objects (MOS), wherein a value of each MO corresponds to a mobility trigger, measure a first frequency range and a second frequency range of the network based on the MOs, detect a first cell in the first frequency range and a second cell in the second frequency range that satisfy the mobility trigger, determine a number of synchronization signal blocks (SSBs) to be transmitted by the first cell and the second cell and determine a periodicity of the SSBs for the first cell and the second cell.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary base station according to various exemplary embodiments.

FIG. 4 shows a diagram of an exemplary network arrangement.

FIG. 5 shows an exemplary method for an improved cell selection logic during mobility operations according to various exemplary embodiments.

### DETAILED DESCRIPTION

The exemplary embodiments may be further understood with reference to the following description and the related appended drawings, wherein like elements are provided with the same reference numerals. The exemplary embodiments relate to improved UE cell selection logic for mobility operations.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network.

Therefore, the UE as described herein is used to represent any electronic component.

The exemplary embodiments are also described with reference to a 5G New Radio (NR) network. However, it should be understood that the exemplary embodiments may also be implemented in other types of networks, including but not limited to LTE networks, future evolutions of the cellular protocol, or any other type of network that assigns, in an unsecured manner, an identifier to a device that is using the network.

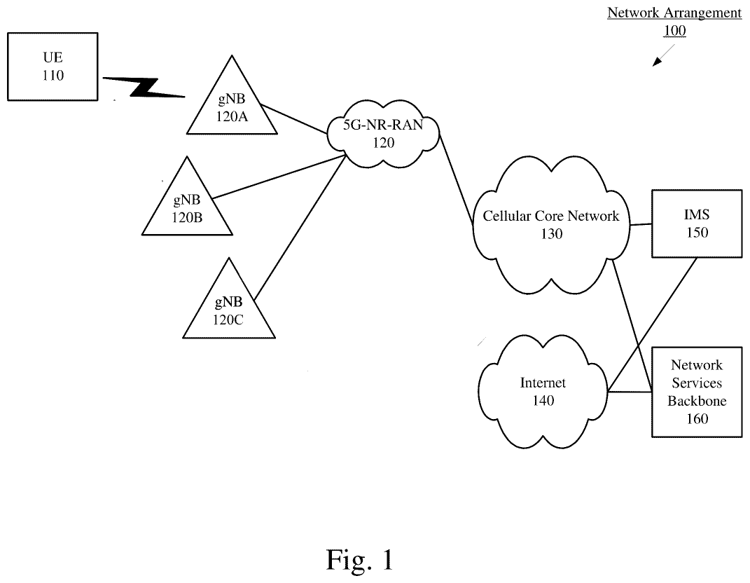

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IOT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., 5G cloud RAN, a next generation RAN (NG-RAN), a legacy cellular network, etc. ) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A, gNB 120B, and gNB 120C. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A or gNB 120B or gNB 120C).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

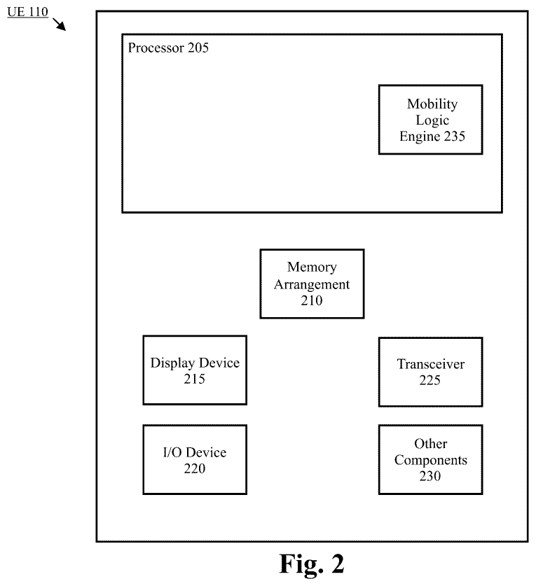

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a mobility logic engine 235 for performing operations including determining which cell should be selected during mobility operations.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G-NR RAN 120. Accordingly, the transceiver 225 may operate on a variety of different frequencies or channels (e.g., set of consecutive frequencies). For example, the transceiver 225 may operate on the unlicensed spectrum when e.g., NR-U is configured. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

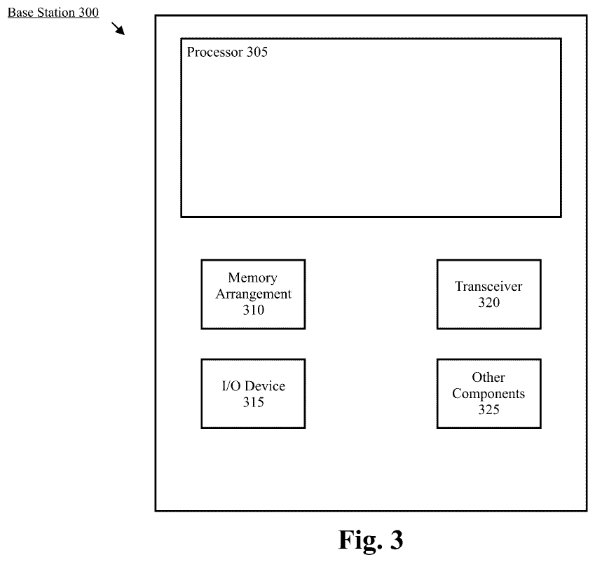

FIG. 3 shows an exemplary base station 300 according to various exemplary embodiments. The base station 300 may represent the gNB 120A or gNB 120B or gNB 120C or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

The transceiver 320 may operate on a variety of different frequencies or channels (e.g., set of consecutive frequencies). Therefore, the transceiver 320 may include one or more components (e.g., radios) to enable the data exchange with the various networks and UEs.

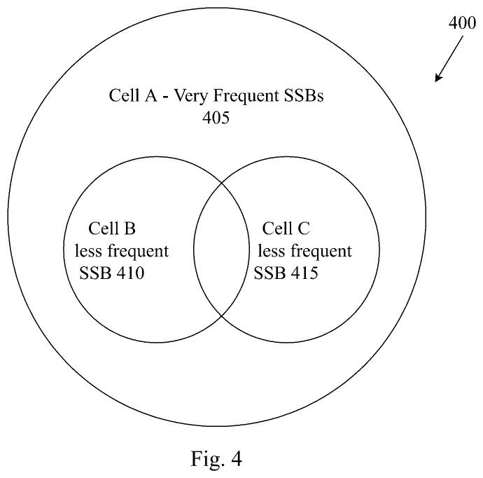

FIG. 4 shows a diagram of an exemplary network arrangement 400 according to various exemplary embodiments. The network arrangement 400 shows one network deployment that may result in a degraded user experience due to mobility operations. However, it should be understood that the network arrangement 400 is only provided to show an example of such network arrangements. There may be many other network arrangements where the same issue exists.

In the example network arrangement 400, a UE (e.g., UE 110) may be located at the intersection of various cells that transmit SSBs more or less frequently as compared to one another. For example, cell A 405 may broadcast SSBs very frequently, cell B 410 may broadcast SSBs less frequently than cell A 405, and cell C 415 may broadcast SSBs less than or equal to the frequency of Cell B 410. Cell A 405 may be a macro-cell that is designed to maximize coverage, whereas cell B 410 and cell C 415 may be small cells that are designed to maximize data throughput. One of skill in the art will understand that the above relationships of the frequency of SSB transmission from the Cells A-C 405-415 is only exemplary. Any number of cells and any number of broadcasts of SSBs in a given time by the cells may be applied to the networking scenario shown in FIG. 4. The UE that exists at the intersection of the cells with various capabilities must decide which cell to pick during mobility operations.

In the above exemplary network arrangement 400, when the UE is performing mobility operations, it is likely that more than one cell may satisfy the criteria for mobility operations. It is desirable for the UE to prefer switching to a cell that will not degrade the UL/DL performance. For example, if a particular cell has a larger SSB periodicity, it may have less restrictions in place, which would prevent decreased performance during mobility operations.

The cellular standards (e.g., 3GPP standards) impose various restrictions related to transmissions that may be sent in the uplink (UL) or received in the downlink (DL) by the UE when the cell to which the UE is connected is transmitting SSBs. Some of these restrictions include, for example, when the UE is operating in Time Division Duplexing (TDD) mode in frequency range 1 (FR1), the UE will not transmit in the UL including Physical Uplink Control Channel (PUCCH), Physical Uplink Shared Channel (PUSCH) or sounding reference signals (SRS) when the cell is transmitting SSBs or for one (1) symbol before or after the SSBs during a SS/PBCH Block Measurement Timing Configuration (SMTC) window.

In another example, when the UE is operating in Frequency Division Duplexing (FDD) mode in FR1 and the deriveSSB_IndexFromCell parameter is enabled, the UE will not transmit in the UL including PUCCH, Channel PUSCH SRS or receive in the DL including Physical Downlink Control Channel (PDCCH), Physical Downlink Shared Channel (PDSCH), tracking reference signals (TRS) or Channel State Information reference signals (CSI-RS) for Channel Quality Index (CQI) when the cell is transmitting SSBs or for one (1) symbol before or after the SSBs during a SMTC window. When the UE is operating in FDD mode in FR1 and the deriveSSB IndexFromCell parameter is not enabled, the UE will not transmit in the UL including PUCCH, Channel PUSCH SRS or receive in the DL including PDCCH, PDSCH, TRS or CSI-RS for CQI during any symbols in the SMTC window.

When the UE is operating in TDD mode in frequency range 2 (FR2) without Reference Signal Receive Quality (RSRQ), the UE will not transmit in the UL including PUCCH, Channel PUSCH SRS or receive in the DL including PDCCH, PDSCH, TRS or CSI-RS for CQI when the cell is transmitting SSBs or for one (1) symbol before or after the SSBs during a SMTC window.

When the UE is operating in TDD mode in frequency range 2 (FR2) with Reference Signal Receive Quality (RSRQ), the UE will not transmit in the UL including PUCCH, Channel PUSCH SRS or receive in the DL including PDCCH, PDSCH, TRS or CSI-RS for CQI when the cell is transmitting SSBs or Received Signal Strength Indicator (RSSI) measurement symbols for one (1) symbol before or after the SSBs/RSSI symbols during a SMTC window.

It should be understood that the above are only some examples of restrictions that may be imposed on the UE in the UL and/or DL when the cell is transmitting SSBs. The exemplary embodiments may be applied when these restrictions or other restrictions are imposed on the UE.

Improved cell selection during mobility allows for reduced power consumption due to the reduced number of measurements and RF switching needed for a given data rate. Another key benefit is higher throughputs on one carrier instead of adding secondary carriers.

Before a UE selects a cell for mobility (or is indicated to select such cell by the network), the network configures Measurement Objects (MOS) for all neighboring frequencies for measurements.

The MOs may include the following configurations (among others) that are included for each frequency: SMTC (e.g., SSB periodicity, number of SSBs), deriveSSBIndexFromCell, RSRQ and RSSI measurement requirements, Sub-Carrier Spacing (SCS), and SSBs to be measured.

Since the UE is aware of the MOs and report configurations, the UE may compare cells in an efficient manner. Specifically, the UE may conclude that one cell has less UL and/or DL restrictions, thus reducing switching complexity and thus a higher data throughput.

In some exemplary embodiments, an improved mobility cell selection logic is provided. The UE (e.g., UE 110) makes a comparison between two cells with the same restriction criteria in place. In this case, there are two relevant quantities to be considered: SSBs to be measured (the number of SSBs) and the periodicity of the SSBs to be measured. If the two cells have different SSB periodicities, and both cells satisfy the criteria to be good target cells, the UE 110 should prefer the cell with the longer SSB periodicity.

Alternatively, the UE 110 may choose the cell with fewer SSBs to be measured, which also leads to less overall restrictions, although the switching time may still be required due the frequent measurements. The logic may still be followed if the difference between cell configurations is only the RSRQ and/or RSSI.

The generalized logic may calculate a weight for each frequency. The weighted factors may include number of SSBs, periodicity of SSBs, RSSI requirement(s), RSRQ requirement(s).

For each type of restriction, the logic adds a “+ve” weight for the corresponding weighted factor. Finally, the logic may report the MO that has the greatest weight first.

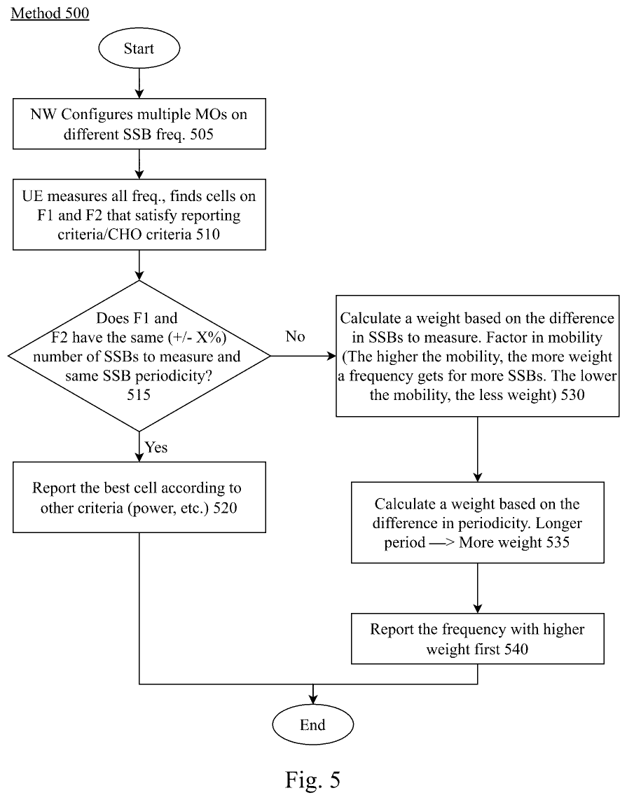

FIG. 5 shows an exemplary method 500 for an improved cell selection logic during mobility operations according to various exemplary embodiments. In this example, it is assumed that both frequencies (FR1 and FR2) may deliver the same performance from all criteria other than SSB configurations.

The method 500 will be described with reference to the network arrangement of FIGS. 1 and 4, e.g., the UE 110, the 5G NR-RAN 120 is the network, the gNBs 120A-C are the cells A-C, respectively.

In 505, the 5G NR-RAN 120 configures multiple MOs on different SSB frequencies and provides the configuration to the UE 110. In 510, the UE 110 measures all the frequencies with configured MOS and finds cells (e.g., gNBs 120A-C) on F1 and F2 that satisfy the reporting criteria/conditional handover (CHO) criteria.

In 515, the UE 110 checks if FR1 and FR2 have the same number of SSBs to measure. The same may include when the number of SSBs is within a predefined percentage (e.g., +/−20%). However, other X % values may be used depending on the implementation. In addition, in 515, the UE 110 also checks if FR1 and FR2 have the same SSB periodicity. Again, the same does not mean identical, just that the periodicity is within a predefined percentage. If FR1 and FR2 have the same number of SSBs to measure and the same periodicity, the method 500 continues to 720 where the UE 110 reports the cell based on other criteria, e.g., power, strength of signal, etc.

If, in 515, FR1 and FR2 do not have the same number of SSBs to measure or the periodicity is different, in 530, the UE 110 calculates a weight based on the difference in SSBs to be measured. The UE 110 factors mobility into the calculation. The higher the mobility, the greater weight a frequency gets for more SSBs. The lower the mobility, the less weight a frequency gets.

In 535, the UE 110 calculates a weight based on the difference in periodicity. The UE 110 weighs longer periods more heavily. In 540, the UE 110 reports the frequency with the highest weight first. After 540 or 525, the network may then determine the cell to which the UE 110 may be handed over based on the reported information.

### Examples

In a first example, a method performed by a user equipment (UE), comprising receiving one or more configured measurement objects (MOS) from a network, wherein a value of each MO corresponds to a mobility trigger, measuring a first frequency range and a second frequency range of the network based on the MOs, detecting a first cell in the first frequency range and a second cell in the second frequency range that satisfy the mobility trigger, determining a number of synchronization signal blocks (SSBs) to be transmitted by the first cell and the second cell and determining a periodicity of the SSBs for the first cell and the second cell.

In a second example, the method of the first example, further comprising, when the number of SSBs for the first cell is within a predetermined amount of the number of SSBs for the second cell and the periodicity of the SSBs for the first cell is within a predetermined amount of the SSBS for the second cell, reporting, to the network, measurement information corresponding to the MOs for the one of the first cell and the second cell based on criteria that is unrelated to the SSBs.

In a third example, the method of the second example, wherein the predetermined amount is 20%.

In a fourth example, the method of the first example, further comprising, when the number of SSBs for the first cell is not within a predetermined amount of the number of SSBs for the second cell or the periodicity of the SSBs for the first cell is not within a predetermined amount of the SSBS for the second cell, calculating a first weight for measurement information corresponding to the MOs for the first cell and the second cell.

In a fifth example, the method of the fourth example, wherein the weight is based on a mobility of the first and second cell, wherein a higher mobility results in a higher weight and a lower mobility results in a lower weight.

In a sixth example, the method of the fourth example, further comprising determining a periodicity of the SSBs for the first cell and the second cell and calculating a second weight for measurement information corresponding to the MOs for the first cell and the second cell based on the periodicity of the SSBs for the first cell and the second cell.

In a seventh example, the method of the sixth example, wherein the second weight is based on a longer periodicity having a higher weight.

In an eighth example, the method of the sixth example, further comprising reporting, to the network, the one of the first and second cell having a highest weighted measurement information corresponding to the MOs.

In a ninth example, the method of the first example, wherein the configured MOS comprise one or more of a Synchronization Signal Block (SSB) based Measurement Timing configuration (SMTC), a deriveSSBIndexFromCell, a Reference Signal Received Power (RSRQ) measurement requirement, a Received Signal Strength Indicator (RSSI) measurement requirement, a Sub-Carrier Spacing, and SSBs to be measured.

In a tenth example, a processor configured to perform any of the methods of the first through ninth examples.

In an eleventh example, a user equipment (UE) comprising a transceiver configured to communicate with a network and a processor communicatively coupled to the transceiver and configured to perform any of the methods of the first through ninth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above-described method may be embodied as a program containing lines of code stored on a non-transitory computer readable storage medium that, when compiled, may be executed on a processor or microprocessor.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus of a user equipment (UE), the apparatus comprising processing circuitry configured to:
decode, based on signals received from a network, one or more measurement objects (MOs), wherein a value of each MO corresponds to a mobility trigger;
measure a first frequency range and a second frequency range of the network based on the MOs;
detect a first cell in the first frequency range and a second cell in the second frequency range that satisfy the mobility trigger;
determine a number of synchronization signal blocks (SSBs) to be transmitted by the first cell and the second cell; and
determine a periodicity of the SSBs for the first cell and the second cell.

2. The apparatus of claim 1, wherein the processing circuitry is further configured to:
when the number of SSBs for the first cell is within a predetermined amount of the number of SSBs for the second cell and the periodicity of the SSBs for the first cell is within a predetermined amount of the SSBS for the second cell, configure transceiver circuitry to report, to the network, measurement information corresponding to the MOs for the one of the first cell and the second cell based on criteria that is unrelated to the SSBs.

3. The apparatus of claim 2, wherein the predetermined amount is 20%.

4. The apparatus of claim 1, wherein the processing circuitry is further configured to:
when the number of SSBs for the first cell is not within a predetermined amount of the number of SSBs for the second cell or the periodicity of the SSBs for the first cell is not within a predetermined amount of the SSBS for the second cell, calculate a first weight for measurement information corresponding to the MOs for the first cell and the second cell.

5. The apparatus of claim 4, wherein the first weight is based on a mobility of the first and second cell, wherein a higher mobility results in a higher weight and a lower mobility results in a lower weight.

6. The apparatus of claim 4, wherein the processing circuitry is further configured to:
determine a periodicity of the SSBs for the first cell and the second cell; and
calculate a second weight for measurement information corresponding to the MOs for the first cell and the second cell based on the periodicity of the SSBs for the first cell and the second cell.

7. The apparatus of claim 6, wherein the second weight is based on a longer periodicity having a higher weight.

8. The apparatus of claim 6, wherein the processing circuitry is further configured to:
configure transceiver circuitry to report, to the network, the one of the first and second cell having a highest weighted measurement information corresponding to the MOs.

9. The apparatus of claim 1, wherein the MOs comprise one or more of a Synchronization Signal Block(SSB) based Measurement Timing configuration (SMTC), a deriveSSBIndexFromCell, a Reference Signal Received Power (RSRQ) measurement requirement, a Received Signal Strength Indicator (RSSI) measurement requirement, a Sub-Carrier Spacing, and SSBs to be measured.

10. A method, comprising:
receiving, from a network, one or more measurement objects (MOs), wherein a value of each MO corresponds to a mobility trigger;
measuring a first frequency range and a second frequency range of the network based on the MOs;
detecting a first cell in the first frequency range and a second cell in the second frequency range that satisfy the mobility trigger;
determining a number of synchronization signal blocks (SSBs) to be transmitted by the first cell and the second cell; and
determining a periodicity of the SSBs for the first cell and the second cell.

11. The method of claim 10, further comprising:
when the number of SSBs for the first cell is within a predetermined amount of the number of SSBs for the second cell and the periodicity of the SSBs for the first cell is within a predetermined amount of the SSBS for the second cell, reporting, to the network, measurement information corresponding to the MOs for the one of the first cell and the second cell based on criteria that is unrelated to the SSBs.

12. The method of claim 11, wherein the predetermined amount is 20%.

13. The method of claim 10, further comprising:
when the number of SSBs for the first cell is not within a predetermined amount of the number of SSBs for the second cell or the periodicity of the SSBs for the first cell is not within a predetermined amount of the SSBS for the second cell, calculating a first weight for measurement information corresponding to the MOs for the first cell and the second cell.

14. The method of claim 13, wherein the first weight is based on a mobility of the first and second cell, wherein a higher mobility results in a higher weight and a lower mobility results in a lower weight.

15. The method of claim 13, further comprising:
determining a periodicity of the SSBs for the first cell and the second cell; and
calculating a second weight for measurement information corresponding to the MOs for the first cell and the second cell based on the periodicity of the SSBs for the first cell and the second cell.

16. The method of claim 15, wherein the second weight is based on a longer periodicity having a higher weight.

17. The method of claim 6, further comprising:
reporting, to the network, the one of the first and second cell having a highest weighted measurement information corresponding to the MOs.

18. The method of claim 10, wherein the MOs comprise one or more of a Synchronization Signal Block(SSB) based Measurement Timing configuration (SMTC), a deriveSSBIndexFromCell, a Reference Signal Received Power (RSRQ) measurement requirement, a Received Signal Strength Indicator (RSSI) measurement requirement, a Sub-Carrier Spacing, and SSBs to be measured.

19. A user equipment (UE), comprising:
a transceiver configured to communicate with a network; and
a processor communicatively coupled to the transceiver and configured to:
decode, based on signals received from the network, one or more measurement objects (MOs), wherein a value of each MO corresponds to a mobility trigger;
measure a first frequency range and a second frequency range of the network based on the MOs;
detect a first cell in the first frequency range and a second cell in the second frequency range that satisfy the mobility trigger;
determine a number of synchronization signal blocks (SSBs) to be transmitted by the first cell and the second cell; and
determine a periodicity of the SSBs for the first cell and the second cell.

20. The UE of claim 19, wherein the processor is further configured to:
when the number of SSBs for the first cell is within a predetermined amount of the number of SSBs for the second cell and the periodicity of the SSBs for the first cell is within a predetermined amount of the SSBS for the second cell, configure the transceiver to report, to the network, measurement information corresponding to the MOs for the one of the first cell and the second cell based on criteria that is unrelated to the SSBs.
